(19) United States
(12) Patent Application Publication
(10) Pub. No.: US 2022/0172029 A1
(43) Pub. Date: Jun. 2, 2022

(54) CIRCUIT FOR IMPLEMENTING SIMPLIFIED SIGMOID FUNCTION AND NEUROMORPHIC PROCESSOR INCLUDING THE CIRCUIT

(71) Applicant: Electronics and Telecommunications Research Institute, Daejeon (KR)

(72) Inventors: In San JEON, Daejeon (KR); Young-Su KWON, Daejeon (KR); Chun-Gi LYUH, Daejeon (KR); Young-deuk JEON, Daejeon (KR); MIN-HYUNG CHO, Daejeon (KR); Jin Ho HAN, Daejeon (KR)

(73) Assignee: Electronics and Telecommunications Research Institute, Daejeon (KR)

(21) Appl. No.: 17/536,536

(22) Filed: Nov. 29, 2021

(30) Foreign Application Priority Data
Nov. 30, 2020 (KR) 10-2020-0164528
May 31, 2021 (KR) 10-2021-0069870

(51) Int. Cl. G06N 3/04; G06N 3/063; G06F 7/544; G06F 7/523; G06F 7/50

(52) U.S. Cl. CPC G06N 3/0481; G06N 3/063; G06F 7/50; G06F 7/523; G06F 7/5443

(57) ABSTRACT

Disclosed is a simplified sigmoid function circuit which includes a first circuit that performs a computation on input data based on a simplified sigmoid function when a sign of a real region of the input data is positive, a second circuit that performs the computation on the input data based on the simplified sigmoid function when the sign of the real region of the input data is negative, and a first multiplexer that selects and output one of an output of the first circuit and an output of the second circuit, based on the sign of the input data. The simplified sigmoid function is obtained by transforming a sigmoid function of a real region into a sigmoid function of a logarithmic region and performing a variational transformation for the sigmoid function of the logarithmic region.

### CROSS-REFERENCE TO RELATED APPLICATIONS

This application claims priority under 35 U.S.C. § 119 to Korean Patent Application Nos. 10-2020-0164528 filed on Nov. 30, 2020, and 10-2021-0069870 filed on May 31, 2021, in the Korean Intellectual Property Office, the disclosures of which are incorporated by reference herein in their entireties.

### BACKGROUND

Embodiments of the present disclosure described herein relate to an artificial intelligence (AI) technology, and more particularly, relate to a simplified sigmoid function circuit used in an artificial neural network (ANN) and a neuromorphic processor including the same.

Recently, the interest in an artificial intelligence (AI) technology being a core technology of the 4^{th} industrial revolution is increasing. Artificial intelligence that is human intelligence artificially implemented with machines, systems, or the like may be based on a learning algorithm called an artificial neural network (ANN). The artificial neural network is a statistical network that processes data in a manner similar to that of a biological neural network. The artificial neural network may be used in various fields such as text recognition, image recognition, voice recognition, and face recognition.

As a technology develops, the complexity of the artificial neural network increases, and the amount and types of data handled through the artificial neural network become vaster. As such, the amount of computation required for the artificial neural network is rapidly increasing. To prevent a data processing speed of the artificial neural network from significantly decreasing due to an increase in the amount of computation, various methods such as tensor decomposition, network pruning, and quantization are proposed to reduce the amount of computation. However, it is difficult to markedly reduce the amount of computation.

### SUMMARY

Embodiments of the present disclosure provide a simplified sigmoid function circuit used in an artificial neural network (ANN) and a neuromorphic processor including the same.

According to an embodiment, a simplified sigmoid function circuit includes a first circuit that performs a computation on input data based on a simplified sigmoid function when a sign of a real region of the input data is positive, a second circuit that performs the computation on the input data based on the simplified sigmoid function when the sign of the real region of the input data is negative, and a first multiplexer that selects and output one of an output of the first circuit and an output of the second circuit, based on the sign of the input data. The simplified sigmoid function is obtained by transforming a sigmoid function of a real region into a sigmoid function of a logarithmic region and performing a variational transformation for the sigmoid function of the logarithmic region.

As an example, the first circuit includes a second multiplexer that selects a first coefficient for the variational transformation, and a third multiplexer that selects a second coefficient for the variational transformation, and the second circuit includes a fourth multiplexer that selects a third coefficient for the variational transformation, and a fifth multiplexer that selects a fourth coefficient for the variational transformation.

As an example, the first circuit further includes a first multiplier that multiplies a magnitude of the input data and the first coefficient together, and a first adder that adds a result of multiplying the magnitude of the input data and the first coefficient together and the second coefficient, and the second circuit further includes a second multiplier that multiplies the magnitude of the input data and the third coefficient together, and a second adder that adds a result of multiplying the magnitude of the input data and the third coefficient together and the fourth coefficient.

As an example, the variational transformation obtains a result approximated through the variational transformation for each section of the input data.

According to an embodiment, a neuromorphic processor includes an artificial neuron-implemented element array that includes a plurality of artificial neuron-implemented elements for performing computation of an artificial neural network. Each of the plurality of artificial neuron-implemented elements includes a summation circuit that multiplies input data and weights and adds results of the multiplication, and an activation function circuit that obtains an activation result from a processing result of the summation circuit through an activation function. The activation function is obtained by transforming a sigmoid function of a real region into a sigmoid function of a logarithmic region and performing a variational transformation for the sigmoid function of the logarithmic region.

As an example, the activation function circuit includes at least one simplified sigmoid function circuit, and the at least one simplified sigmoid function circuit includes a first circuit that performs a computation on the input data based on a simplified sigmoid function when a sign of a real region of the input data is positive, a second circuit that performs the computation on the input data based on the simplified sigmoid function when the sign of the real region of the input data is negative, and a first multiplexer that selects and outputs one of an output of the first circuit and an output of the second circuit, based on the sign of the input data.

As an example, the first circuit further includes a first multiplier that multiplies a magnitude of the input data and a first coefficient together, and a first adder that adds a result of multiplying the magnitude of the input data and the first coefficient together and a second coefficient, and the second circuit further includes a second multiplier that multiplies the magnitude of the input data and a third coefficient together, and a second adder that adds a result of multiplying the magnitude of the input data and the third coefficient together and a fourth coefficient.

As an example, the first circuit further includes a second multiplexer that selects the first coefficient for the variational transformation, and a third multiplexer that selects the second coefficient for the variational transformation, and the second circuit further includes a fourth multiplexer that selects the third coefficient for the variational transformation, and a fifth multiplexer that selects the fourth coefficient for the variational transformation.

As an example, the variational transformation obtains a result approximated through the variational transformation for each section of the input data.

As an example, the neuromorphic processor further includes an input/output unit that receives the input data from the outside and outputs a computation result of the artificial neural network associated with the input data to the outside, a control logic unit that receives the input data from the input/output unit and transfers the input data, a word line bias unit that transfers the input data provided from the control logic unit to the artificial neuron-implemented element array, and a bit line bias and detect unit that detects the computation result associated with the input data from the artificial neuron-implemented element array.

As an example, the neuromorphic processor further includes a nonvolatile memory that stores information about a connection relationship of the plurality of artificial neuron-implemented elements included in the artificial neuron-implemented element array, and a volatile memory that stores the computation result detected from the artificial neuron-implemented element array.

### BRIEF DESCRIPTION OF THE FIGURES

The above and other objects and features of the present disclosure will become apparent by describing in detail embodiments thereof with reference to the accompanying drawings.

FIG. 1 is a diagram illustrating an artificial neural network according to an embodiment of the present disclosure.

FIG. 2 is a diagram illustrating an artificial neuron according to an embodiment of the present disclosure.

FIG. 3 is a diagram illustrating a simplified sigmoid function circuit according to an embodiment of the present disclosure.

FIG. 4 is a diagram illustrating a neuromorphic processor to which a simplified sigmoid function circuit according to an embodiment of the present disclosure is applied.

### DETAILED DESCRIPTION

Below, embodiments of the present disclosure will be described in detail and clearly to such an extent that one skilled in the art easily carries out the present disclosure.

The terms used in the specification are provided to describe the embodiments, not to limit the present disclosure. As used in the specification, the singular terms “a,” “an” and “the” are intended to include the plural forms as well, unless the context clearly indicates otherwise. The terms “comprises” and/or “comprising,” when used in the specification, specify the presence of steps, operations, elements, and/or components, but do not preclude the presence or addition of one or more other steps, operations, elements, components, and/or groups thereof.

In the specification, the term “first and/or second” will be used to describe various elements but will be described only for the purpose of distinguishing one element from another element, not limiting an element of the corresponding term. For example, without departing the scope of the present disclosure, a first element may be referred to as a second element, and similarly, a second element may be referred to as a first element.

Unless otherwise defined, all terms (including technical and scientific terms) used in the specification should have the same meaning as commonly understood by those skilled in the art to which the present disclosure pertains. The terms, such as those defined in commonly used dictionaries, should not be interpreted in an idealized or overly formal sense unless expressly so defined herein. The same reference numerals represent the same elements throughout the specification.

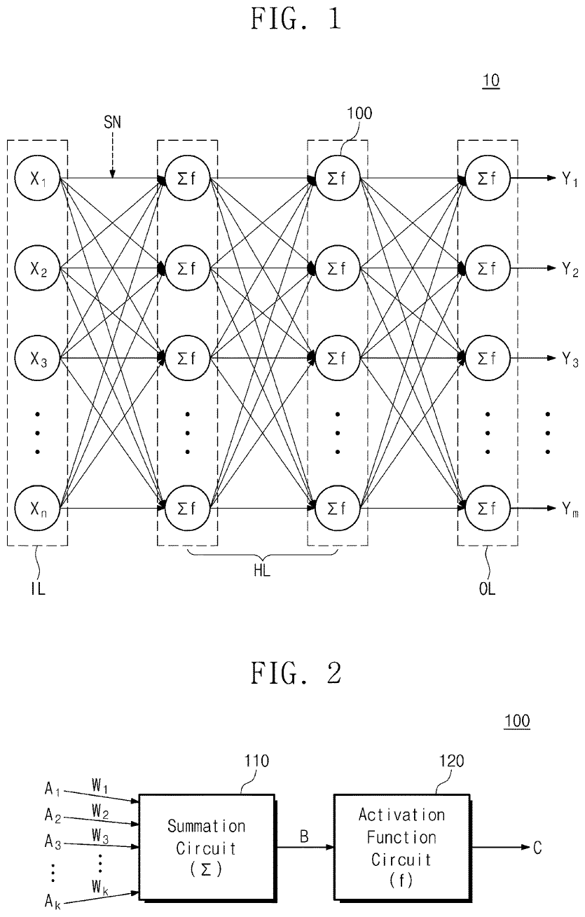

FIG. 1 is a diagram illustrating an artificial neural network (ANN) 10 according to an embodiment of the present disclosure. Referring to FIG. 1, the artificial neural network 10 according to an embodiment of the present disclosure may include an input layer IL, a hidden layer HL, and an output layer OL. The input layer IL, the hidden layer HL, and the output layer OL may be connected to each other through synapses SN.

The artificial neural network 10 may include a plurality of artificial neurons 100. The plurality of artificial neurons 100 may include a plurality of input neurons that receive input data X₁, X₂ . . . Xₙ from the outside, a plurality of hidden neurons that receive data from the plurality of input neurons and process the received data, and a plurality of output neurons that receive data from the plurality of hidden neurons and generate output data Y₁, Y₂ . . . Yₘ. The input layer IL may include the plurality of input neurons, the hidden layer HL may include the plurality of hidden neurons, and the output layer OL may include the plurality of output neurons.

The number of artificial neurons included in the input layer IL, the hidden layer HL, and the output layer OL is not limited to the example illustrated in FIG. 1. Also, the hidden layer HL may include more layers than those illustrated in FIG. 1. The number of layers included in the hidden layer HL may be associated with the accuracy and the learning speed of the artificial neural network 10. Also, the input data X₁, X₂ . . . Xₙ and the output data Y₁, Y₂ . . . Yₘ may be various types of data such as a text and an image.

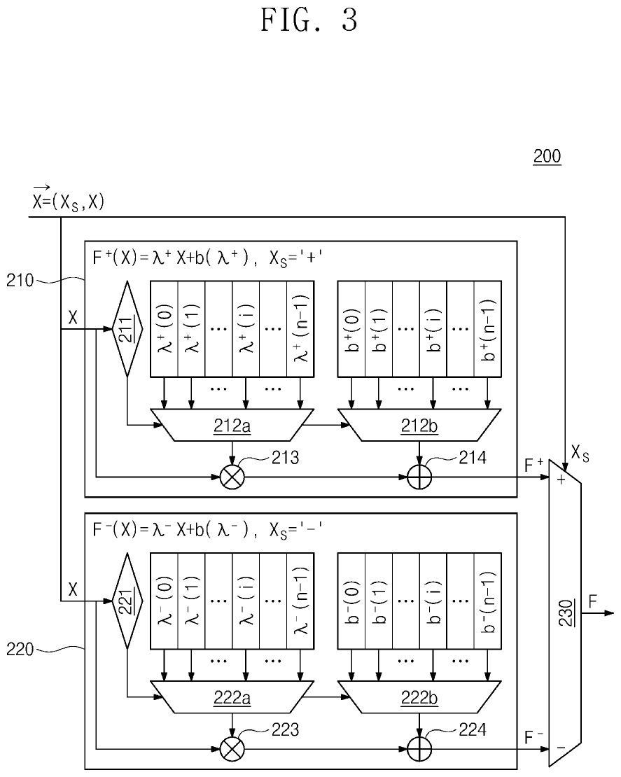

FIG. 2 is a diagram illustrating the artificial neuron 100 according to an embodiment of the present disclosure. Referring to FIG. 2, the artificial neuron 100 may include a summation circuit 110 and an activation function circuit 120.

The summation circuit 110 may sum input signals A₁, A₂ . . . A_{K} by using weights W₁, W₂ . . . W_{K}. Each of the input signals A₁, A₂ . . . A_{K} may be an output signal generated from an arbitrary artificial neuron. Each of the weights W₁, W₂ . . . W_{K} may indicate the strength of the synapse SN (refer to FIG. 1), that is, the degree of connection between one artificial neuron and another artificial neuron. The summation circuit 110 may obtain a summation result “B” by multiplying each of the input signals A₁, A₂ . . . A_{K} and each of the weights W₁, W₂ . . . W_{K} together and summing multiplication results. The summation result “B” may be expressed by Equation 1 below.

$$\begin{matrix}[ Equation 1 ] & \\ B = {\sum }_{i = 1}^{k} {A}_{i} \times {W}_{i} . & \end{matrix}$$

The activation function circuit 120 may obtain an activation result “C” by using the summation result “B” and an activation function “f”. The activation function “f” according to an embodiment of the present disclosure may be a simplified sigmoid function. The sigmoid function may be used to obtain a non-linear value from a multi-layer perceptron being linear, and may include, for example, a logistic function. The sigmoid function may be defined in a real number part and may be expressed by Equation 2 below. In Equation 2, sig(x) means a sigmoid function of a real number part, and “x” means a real variable.

$$\begin{matrix}[ Equation 2 ] & \\ sig ( x ) = \frac{1}{1 + {e}^{- x}} . & \end{matrix}$$

In an embodiment of the present disclosure, to reduce the amount of computation of an artificial neural network, a simplified sigmoid function that is used as the activation function “f” may be of a form obtained by variational transforming the sigmoid function in a logarithmic region. That is, the activation function “f” that is used in the embodiment of the present disclosure may be obtained through the process of obtaining the sigmoid function of the logarithmic region and variational transforming the sigmoid function of the logarithmic region thus obtained.

The sigmoid function of the logarithmic region may be derived by taking a natural logarithm of both sides of the sigmoid function of the real region expressed in Equation 2. The process of deriving the sigmoid function of the logarithmic region may be expressed by (1) to (4) of Equation 3 below. In Equation 3, sig(x) means the sigmoid function of the real region, SIG(X) means the sigmoid function of the logarithmic region, “x” means a real variable, and “X” means a variable of the logarithmic region. Below, for convenience, “ex” is expressed in the form of exp(x).

$$\begin{matrix}[ Equation 3 ] & \\ ln \{ sig ( x ) \} = ln \{ \frac{1}{1 + exp ( - x )} \} & ( 1 ) \\ X = ln ( x ) & ( 2 ) \\ x = exp ( X ) & ( 3 ) \\ SIG ( X ) = - ln [ 1 + exp ( - exp ( X ) ) ] & ( 4 )\end{matrix}$$

The sigmoid function of the logarithmic region obtained from Equation 3 above may be variational transformed to reduce the amount of computation of the artificial neural network. The variational transformation of the sigmoid function of the logarithmic region may be differently derived depending on a sign of the real variable “x”. First, when the real variable “x” is a positive number, a derivation process may be expressed by (1) to (12) of Equation 4. In Equation 4, F(x) means an approximate expression obtained through the variational transformation, and D(x) means a difference between the sigmoid function SIG(X) of the logarithmic region and the approximate expression. Also, “Y” means a function of minimizing D(x).

$$\begin{matrix}[ Equation 4 ] & \\ F ( x ) = λ X + b ( λ ) & ( 1 ) \\ D ( x ) = F ( x ) - G ( x ) = λ X + b ( λ ) - ( - ln [ 1 + exp ( - exp ( X ) ) ] ) & ( 2 ) \\ Y = minλ \{ λ X + b ( λ ) + ln [ 1 + exp ( - exp ( X ) ) ] \} & ( 3 ) \\ \frac{dY}{dx} = ( \frac{d}{dx} ) ( λ X + b ( λ ) + ln [ 1 + exp ( - exp ( x ) ) ] \} = 0 & ( 4 ) \\ λ = exp ( x ) exp \{ - exp ( X ) \} \text{/} [ 1 + exp ( - exp ( X ) ) ] & ( 5 ) \\ exp ( X ) = t & ( 6 ) \\ λ = t exp ( - t ) \text{/} ( 1 + exp ( - t ) ) & ( 7 ) \\ X = H ( λ ) & ( 8 ) \\ D ( X ) = λ X + b ( λ ) + ln [ 1 + exp ( - exp ( X ) ) ] = 0 & ( 9 ) \\ λ H ( λ ) + b ( λ ) + ln [ 1 + exp ( - exp ( H ( λ ) ) ) ] = 0 & ( 10 ) \\ b ( λ ) = - λ * H ( λ ) - ln [ 1 + exp ( - exp ( H ( λ ) ) ) ] & ( 11 ) \\ F ( X ) = λ X - λ * H ( λ ) - ln [ 1 + exp ( - exp ( H ( λ ) ) ) ] & ( 12 )\end{matrix}$$

When the real variable “x” is a negative number, the sigmoid function of the logarithmic region is expressed by Equation 5 below. In Equation 5, because “x” is a negative number, it may be expressed by a product of xp being a positive number and −1. In Equation 5, sig(x) means the sigmoid function in the real region, and SIG(Xp) means the sigmoid function of the logarithmic region.

$$\begin{matrix}[ Equation 5 ] & \\ sig ( x ) = \{ 1 \text{/} ( 1 + exp ( xp ) ) \} & ( 1 ) \\ SIG ( Xp ) = - ln [ 1 + exp \{ exp ( Xp ) \} ] & ( 2 )\end{matrix}$$

When the real variable “x” is a negative number, a derivation process may be expressed by (1) to (12) of Equation 6. In Equation 6, F(x) means an approximate expression obtained through the variational transformation, and D(x) means a difference between the sigmoid function SIG(Xp) of the logarithmic region and the approximate expression. Also, “Y” means a function of minimizing D(xp).

$$\begin{matrix}[ Equation 6 ] & \\ F ( x ) = λ Xp + b ( λ ) & ( 1 ) \\ D ( Xp ) = F ( Xp ) - SIG ( Xp ) = λ Xp + b ( λ ) - ( - ln [ 1 + exp ( - exp ( Xp ) ) ] ) & ( 2 ) \\ Y = minλ \{ λ Xp + b ( λ ) + ln [ 1 + exp ( - exp ( Xp ) ) ] \} & ( 3 ) \\ \frac{dY}{dx} = ( \frac{d}{dx} ) ( λ Xp + b ( λ ) + ln [ 1 + exp ( - exp ( x ) ) ] \} = 0 & ( 4 ) \\ λ = exp ( x ) exp \{ - exp ( Xp ) \} \text{/} [ 1 + exp ( - exp ( X ) ) ] & ( 5 ) \\ exp ( Xp ) = t & ( 6 ) \\ λ = t exp ( - t ) \text{/} ( 1 + exp ( - t ) ) & ( 7 ) \\ X = HH ( λ ) & ( 8 ) \\ D ( Xp ) = λ Xp + b ( λ ) + ln [ 1 + exp ( - exp ( Xp ) ) ] = 0 & ( 9 ) \\ λ HH ( λ ) + b ( λ ) + ln [ 1 + exp ( - exp ( HH ( λ ) ) ) ] = 0 & ( 10 ) \\ b ( λ ) = - λ * HH ( λ ) - ln [ 1 + exp ( - exp ( HH ( λ ) ) ) ] & ( 11 ) \\ F ( Xp ) = λ Xp - λ * HH ( λ ) - ln [ 1 + exp ( - exp ( HH ( λ ) ) ) ] & ( 12 )\end{matrix}$$

The approximate expressions F(X) and F(Xp) obtained through Equation 4 and Equation 6 may be used as the activation function “f” for obtaining the activation result “C” in the activation function circuit 120.

FIG. 3 is a diagram illustrating a simplified sigmoid function circuit 200 according to an embodiment of the present disclosure. The simplified sigmoid function circuit 200 that is a circuit for implementing the activation function “f” may be included in the activation function circuit 120 (refer to FIG. 2). Referring to FIG. 3, the simplified sigmoid function circuit 200 may include a first circuit 210, a second circuit 220, and a first multiplexer 230. The first circuit 210 may include a first comparator 211, a second multiplexer 212a, a third multiplexer 212b, a first multiplier 213, and a first adder 214. The second circuit 220 may include a second comparator 221, a fourth multiplexer 222a, a fifth multiplexer 222b, a second multiplier 223, and a second adder 224.

According to an embodiment of the present disclosure, an activation result “F” (corresponding to the activation result “C” described with reference to FIG. 2) may be obtained through the simplified sigmoid function circuit 200. In a logarithmic domain, an input \vec{X} that is a vector may be expressed by sign Xs being a direction and magnitude “X”. When a direction sign of the input \vec{X} is (+), an output value of the first circuit 210 may be obtained as the activation result “F”. When the direction sign of the input \vec{X} is (−), an output value of the second circuit 220 may be obtained as the activation result “F”.

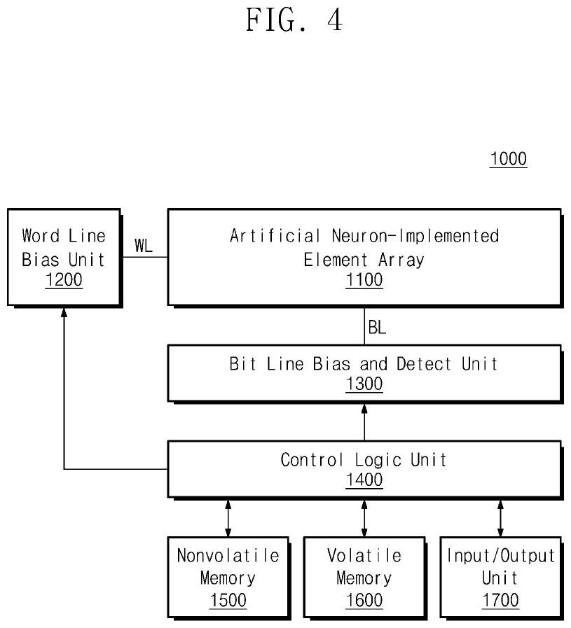

FIG. 4 is a diagram illustrating a neuromorphic processor 1000 to which the simplified sigmoid function circuit 200 (refer to FIG. 3) according to an embodiment of the present disclosure is applied. Referring to FIG. 4, the neuromorphic processor 1000 may include an artificial neuron-implemented element array 1100, a word line bias unit 1200, a bit line bias and detect unit 1300, a control logic unit 1400, a nonvolatile memory 1500, a volatile memory 1600, and an input/output unit 1700.

The artificial neuron-implemented element array 1100 may correspond to hardware implementation of the artificial neural network 10 described with reference to FIG. 1. The artificial neuron-implemented element array 1100 may include elements (hereinafter referred to as “artificial neuron-implemented elements”) in which the plurality of artificial neurons 100 (refer to FIG. 1) are implemented, and the plurality of artificial neuron-implemented elements may be arranged in rows and columns in structure. Each of the plurality of artificial neuron-implemented elements may include the simplified sigmoid function circuit 200 described with reference to FIG. 3. The artificial neuron-implemented element array 1100 may output a result value based on the simplified sigmoid function. To prevent a complicated drawing, one word line WL and one bit line BL are illustrated in FIG. 4 as being connected with the artificial neuron-implemented element array 1100, but mean the word line WL and the bit line BL that are connected with each artificial neuron-implemented element 100 included in the artificial neuron-implemented element array 1100.

The word line bias unit 1200 may receive input data from the control logic unit 1400 and may transfer the input data to each artificial neuron-implemented element included in the artificial neuron-implemented element array 1100 through the word line WL. Also, the word line bias unit 1200 may supply a current for recording a weight to connections of a plurality of synapses SN (refer to FIG. 1) included in the artificial neuron-implemented element array 1100 through the word line WL.

The bit line bias and detect unit 1300 may supply a ground voltage to the bit line BL in an artificial neural network operation of each artificial neuron-implemented element included in the artificial neuron-implemented element array 1100. Also, the bit line bias and detect unit 1300 may obtain a result of the operation of each artificial neuron-implemented element included in the artificial neuron-implemented element array 1100 by detecting a current amount through the bit line BL.

The control logic unit 1400 may read information stored in the nonvolatile memory 1500 and may control the word line bias unit 1200 and the bit line bias and detect unit 1300 based on the read information. Also, the control logic unit 1400 may transfer an initial input received through the input/output unit 1700 to the word line bias unit 1200 as input data or may store the initial input in the volatile memory 1600. Also, the control logic unit 1400 may transfer a result output from the artificial neuron-implemented element array 1100 to the word line bias unit 1200 as input data or may store the result in the volatile memory 1600.

The nonvolatile memory 1500 may store information about a connection relationship of the artificial neuron-implemented elements included in the artificial neuron-implemented element array 1100. That is, the nonvolatile memory 1500 may include information about the entire structure of a neural network implemented by the neuromorphic processor 1000.

The volatile memory 1600 may store the initial input provided from the input/output unit 1700 and the result output from the artificial neuron-implemented element array 1100. The input/output unit 1700 may receive initial input from the outside and may transfer the initial input to the control logic unit 1400; the input/output unit 1700 may receive the output result of the artificial neuron-implemented element array 1100 from the control logic unit 1400 and may output the result to the outside.

According to the present disclosure, a simplified sigmoid function circuit may markedly reduce the amount of computation of an artificial neural network by processing a sigmoid function, in which computation is made in a real region, in a logarithmic region. A neuromorphic processor including the simplified sigmoid function circuit may also reduce the amount of computation through the same processing.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A simplified sigmoid function circuit comprising:
a first circuit configured to perform a computation on input data based on a simplified sigmoid function when a sign of a real region of the input data is positive;
a second circuit configured to perform the computation on the input data based on the simplified sigmoid function when the sign of the real region of the input data is negative; and
a first multiplexer configured to select and output one of an output of the first circuit and an output of the second circuit, based on the sign of the input data,
wherein the simplified sigmoid function is obtained by transforming a sigmoid function of a real region into a sigmoid function of a logarithmic region and performing a variational transformation for the sigmoid function of the logarithmic region.

2. The simplified sigmoid function circuit of claim 1, wherein the first circuit includes:
a second multiplexer configured to select a first coefficient for the variational transformation; and
a third multiplexer configured to select a second coefficient for the variational transformation, and
wherein the second circuit includes:
a fourth multiplexer configured to select a third coefficient for the variational transformation; and
a fifth multiplexer configured to select a fourth coefficient for the variational transformation.

3. The simplified sigmoid function circuit of claim 2, wherein the first circuit further includes:
a first multiplier configured to multiply a magnitude of the input data and the first coefficient together; and
a first adder configured to add a result of multiplying the magnitude of the input data and the first coefficient together and the second coefficient, and
wherein the second circuit further includes:
a second multiplier configured to multiply the magnitude of the input data and the third coefficient together; and
a second adder configured to add a result of multiplying the magnitude of the input data and the third coefficient together and the fourth coefficient.

4. The simplified sigmoid function circuit of claim 1, wherein the variational transformation obtains a result approximated through the variational transformation for each section of the input data.

5. A neuromorphic processor comprising:
an artificial neuron-implemented element array including a plurality of artificial neuron-implemented elements for performing computation of an artificial neural network,
wherein each of the plurality of artificial neuron-implemented elements includes:
a summation circuit configured to multiply input data and weights and add results of the multiplication; and
an activation function circuit configured to obtain an activation result from a processing result of the summation circuit through an activation function,
wherein the activation function is obtained by transforming a sigmoid function of a real region into a sigmoid function of a logarithmic region and performing a variational transformation for the sigmoid function of the logarithmic region.

6. The neuromorphic processor of claim 5, wherein the activation function circuit includes at least one simplified sigmoid function circuit,
wherein the at least one simplified sigmoid function circuit includes:
a first circuit configured to perform a computation on the input data based on a simplified sigmoid function when a sign of a real region of the input data is positive;
a second circuit configured to perform the computation on the input data based on the simplified sigmoid function when the sign of the real region of the input data is negative; and
a first multiplexer configured to select and output one of an output of the first circuit and an output of the second circuit, based on the sign of the input data.

7. The neuromorphic processor of claim 6, wherein the first circuit further includes:
a first multiplier configured to multiply a magnitude of the input data and a first coefficient together; and
a first adder configured to add a result of multiplying the magnitude of the input data and the first coefficient together and a second coefficient, and
wherein the second circuit further includes:
a second multiplier configured to multiply the magnitude of the input data and a third coefficient together; and
a second adder configured to add a result of multiplying the magnitude of the input data and the third coefficient together and a fourth coefficient.

8. The neuromorphic processor of claim 7, wherein the first circuit further includes:
a second multiplexer configured to select the first coefficient for the variational transformation; and
a third multiplexer configured to select the second coefficient for the variational transformation, and
wherein the second circuit further includes:
a fourth multiplexer configured to select the third coefficient for the variational transformation; and
a fifth multiplexer configured to select the fourth coefficient for the variational transformation.

9. The neuromorphic processor of claim 5, wherein the variational transformation obtains a result approximated through the variational transformation for each section of the input data.

10. The neuromorphic processor of claim 5, further comprising:
an input/output unit configured to receive the input data from the outside and to output a computation result of the artificial neural network associated with the input data to the outside;
a control logic unit configured to receive the input data from the input/output unit and to transfer the input data;
a word line bias unit configured to transfer the input data provided from the control logic unit to the artificial neuron-implemented element array; and
a bit line bias and detect unit configured to detect the computation result associated with the input data from the artificial neuron-implemented element array.

11. The neuromorphic processor of claim 5, further comprising:
a nonvolatile memory configured to store information about a connection relationship of the plurality of artificial neuron-implemented elements included in the artificial neuron-implemented element array; and
a volatile memory configured to store the computation result detected from the artificial neuron-implemented element array.
